(19) United States
(12) Patent Application Publication
(10) Pub. No.: US 2012/0082188 A2
(43) Pub. Date: Apr. 5, 2012

(54) MULTIPLE REDUNDANT GNSS SYNCHRONIZATION SYSTEM

(75) Inventors: Charles Nicholls, Nepean, ON (CA); Michel Ouellette, Orleans, ON (CA)

(73) Assignee: NORTEL NETWORKS LIMITED, St. Laurent, QC (CA)

(21) Appl. No.: 13/132,464

(22) PCT Filed: Dec. 3, 2009
(86) PCT No.: PCT/CA2009/001797

§ 371 Date: Jun. 2, 2011

Related U.S. Application Data
(60) Provisional application No. 61/119,628, filed on Dec. 3, 2008.

(51) Int. Cl. H04L 7/00; H04B 1/707

(52) U.S. Cl. 375/145; 375/356; 375/E01.002

(57) ABSTRACT

Methods and apparatus are provided for multiple redundant global navigation satellite system GNSS synchronization of a plurality of base stations via a system node that is in communication with the plurality of base stations. At the system node, time information is provided to and received from the plurality of base stations and a system time reference is generated based on at least some of the time information, such that the system time reference is synchronized with an external time epoch reference provided by the GNSS. If a base station is unable to receive the GNSS service, the system node provides time synchronization information to the base station to synchronize the base station with the system time reference, which itself is synchronized to the external time epoch reference provided by the GNSS service.

### RELATED APPLICATION

The present patent application claims the benefit of and is a National Phase Entry of International Application No. PCT/CA2009/001797 filed Dec. 3, 2009, and claims the benefit of U.S. Provisional Patent Application No. 61/119,628 filed Dec. 3, 2008, the entire contents of which are incorporated herein by reference.

### FIELD OF THE INVENTION

The present invention relates to time synchronization in wireless communications.

### BACKGROUND

Many base station deployments that are reliant on GNSS (global navigation satellite system) systems, such as the GPS (global positioning system) system, for timing synchronization are subject to loss of synchronization as a result of interference in the GPS signalling band or damage to the GPS receiving antenna system at a base station. In many conventional systems, in the event that GPS service is interrupted, the base station clock oscillator, which is normally disciplined by the external time epoch reference provided by the GPS service, will go into a holdover state in which a local oscillator model is used to control the base station clock oscillator to try to maintain timing accuracy while waiting for return of the GPS service.

In many cases, the radio standard under which the base station is operating defines the required time accuracy during holdover. For example, in 3GPP2, the synchronization accuracy must be maintained within a 10 μs window defining the holdover period.

The ability of the base station clock to meet the holdover timing specification is typically dependent on the degree to which the local oscillator model has been trained. In some instances, interferences, such as loss of the GPS service, can occur at the time of deployment of the base station preventing sufficient training of the adaptive algorithms that are used as part of the oscillator model during a holdover event, thereby potentially reducing the available holdover time.

Even in the event that the holdover specification can be met, the base station quality of service is typically diminished with respect to soft handoff capability because of the relaxed timing accuracy that is typically allowed during a holdover event. Furthermore, if the holdover duration is exceeded, the base station functionality typically continues to decline as the base station clock oscillator drifts further out of synchronization with the external time epoch reference, and thus out of synchronization with the rest of the system that is synchronized to the external time epoch reference, to the point where calls may be dropped during handoff.

### SUMMARY OF THE INVENTION

According to one broad aspect of the present invention, there is provided a method in a system node, the system node in communication with a plurality of base stations each having an internal clock, the method comprising: providing time information to, and receiving time information from, each of the plurality of base stations; generating a system time reference based on at least some of the time information; and for a base station of the plurality of base stations that does not have its internal clock synchronized with an external time epoch reference, providing time synchronization information to the base station to synchronize the internal clock of the base station with the system time reference.

In some embodiments, generating a system time reference based on at least some of the time information comprises: generating a system time reference based on at least some of the time information received from at least one base station that has its internal clock synchronized with the external time epoch reference.

In some embodiments, providing time information to, and receiving time information from, each of the plurality of base stations comprises: for each base station: providing time stamp information to, and receiving time stamp information from, the base station, wherein the system node generates time stamp information based on the system time reference and the base station generates time stamp information based on its internal clock.

In some embodiments, generating the system time reference comprises synchronizing a system node clock at the system node with the external time epoch reference based on the at least some of the time information.

In some embodiments, generating the system time reference comprises: for each base station with its internal clock synchronized to the external time epoch reference, determining a respective time offset between the internal clock of the base station and the system node clock at the system node; and controlling the system node clock based on an average of the respective time offsets for those base stations with internal clocks synchronized to the external time epoch reference; and generating the system time reference based on an output of the system node clock.

In some embodiments, generating the system time reference comprises: for each base station, generating a respective system node clock at the system node and controlling the respective system node clock based on at least some of the time information received from the base station to synchronize the respective system node clock with the internal clock of the base station; and generating the system time reference based on an average of the respective system node clocks corresponding to those base stations with their internal clock synchronized to the external time epoch reference.

In some embodiments, providing time information to, and receiving time information from, each of the plurality of base stations comprises: providing and receiving the time information using a two-way time transfer protocol.

In some embodiments, providing time synchronization information to a base station of the plurality of base stations that does not have its internal clock synchronized with the external time epoch reference to synchronize the internal clock of the base station with the system time reference comprises: providing time synchronization information to the base station pursuant to receiving an external time epoch reference lock status message from the base station that indicates that the internal clock of the base station has lost synchronization with the external time epoch reference.

In some embodiments, the method further comprises; determining that the internal clock of a base station of the plurality of base stations has lost synchronization with the external time epoch reference based on a deviation of the time information received from the base station relative to the system time reference.

In some embodiments, providing and receiving time information and providing time synchronization information comprises communicating via packet-based communication.

According to another broad aspect of the present invention, there is provided a system node comprising: a communication interface configured to provide time information to, and receive time information from, a plurality of base stations, each having an internal clock; a system node clock; and a system node clock controller configured to: control the system node clock based on at least some of the time information received from at least one of the plurality of base stations; generate a system time reference based on an output of the system node clock; and for a base station of the plurality of base stations that does not have its internal clock synchronized with an external time epoch reference, provide time synchronization information to the base station to synchronize the internal clock of the base station with the system time reference.

In some embodiments, the system node clock controller is configured to control the system node clock based on at least some of the time information received from each base station that has its internal clock synchronized with the external time epoch reference.

In some embodiments, the communication interface is configured to provide time information to, and receive time information from the plurality of base stations by providing and receiving time stamp information, wherein the communication interface is configured to generate time stamp information based on the system time reference and receive time stamp information from each base station generated based on the base station's internal clock.

In some embodiments, the system node clock controller is configured to generate the system time reference by synchronizing the system node clock with the external time epoch reference based on at least some of the time information received from at least one base station of the plurality of base stations that has its internal clock synchronized with the external epoch time reference.

In some embodiments, the system node clock controller is configured to: for each base station with its internal clock synchronized to the external time epoch reference, determine a respective time offset between the internal clock of the base station and the system node clock at the system node; and control the system node clock based on an average of the respective time offsets for those base stations with their internal clock synchronized to the external time epoch reference.

In some embodiments, the system node clock comprises a respective system node clock for each base station, and wherein the system node clock controller is configured to: for each base station, control the respective system node clock based on at least some of the time information received from the base station to synchronize the respective system node clock with the internal clock of the base station; and generate the system time reference based on an average of the respective system node clocks corresponding to those base stations with their internal clock synchronized to the external time epoch reference.

In some embodiments, the communication interface comprises a respective two-way time transfer protocol interface for each base station.

In some embodiments, the system node clock controller is configured to provide the time synchronization information to a base station pursuant to receiving an external time epoch reference lock status message from the base station that indicates that the internal clock of the base station has lost synchronization with the external time epoch reference.

In some embodiments, the system node clock controller is configured to determine that the internal clock of a base station of the plurality of base stations has lost synchronization with the external time epoch reference based on a deviation of the time information received from the base station relative to the system time reference.

In some embodiments, the communication interface is configured to communicate using packet-based communication.

According to yet another broad aspect of the present invention, there is provided a communication system comprising: a system node; and a plurality of base stations, each having an internal clock and a respective communication link with the system node, wherein the system node is configured to; exchange time information with each of the plurality of base stations; generate a system time reference based on at least some of the time information; and for a base station of the plurality of base stations that does not have its internal clock synchronized with an external time epoch reference, provide time synchronization information to the base station to synchronize the internal clock of the base station with the system time reference.

In some embodiments, the system node is configured to generate the system time reference based on at least some of the time information exchanged with at least one of the base stations that has its internal clock synchronized with the external time epoch reference.

In some embodiments, the system node and the plurality of base stations are configured to exchange time information by exchanging time stamp information, wherein the system node generates time stamp information based on the system time reference and each base station generates time stamp information based on its internal clock.

In some embodiments, the system node is configured to generate the system time reference by synchronizing a system node clock at the system node with the external time epoch reference based on the at least some of the time information exchanged with the at least one of the base stations that has its internal clock synchronized with the external time epoch reference.

In some embodiments, the system node is configured to: for each base station with its internal clock synchronized to the external time epoch reference, determine a respective time offset between the internal clock of the base station and the system node clock at the system node; and control the system node clock based on an average of the respective time offsets for those base stations with internal clocks synchronized to the external time epoch reference; and generate the system time reference based on an output of the system node clock.

In some embodiments, the system node is configured to: for each base station, generate a respective system node clock at the system node and control the respective system node clock based on at least some of the time information exchanged with the base station to synchronize the respective system node clock with the internal clock of the base station; and generate the system time reference based on an average of the respective system node clocks corresponding to those base stations with their internal clock synchronized to the external time epoch reference.

In some embodiments, the system node and the plurality of base stations are configured to exchange the time information using a two-way time transfer protocol.

In some embodiments, the system node is configured to provide the time synchronization information to a base station of the plurality of base stations pursuant to receiving an external time epoch reference lock status message from the base station that indicates that the internal clock of the base station has lost synchronization with the external time epoch reference.

In some embodiments, the system node is configured to determine that the internal clock of a base station of the plurality of base stations has lost synchronization with the external time epoch reference based on a deviation of the time information received from the base station relative to the system time reference.

In some embodiments, the system node and the plurality of base stations are configured to communicate using packet-based communication.

In some embodiments, at least one but not all of the plurality of base stations is located such that it is unable to receive a global navigation satellite system GNSS signal containing the external time epoch reference.

In some embodiments, the plurality of base stations comprises a plurality of femto cells, and wherein, for at least one of the plurality of femto cells, the respective communication link between the femto cell and the system node comprises an asynchronous digital subscriber line ADSL communication link.

According to a further broad aspect of the present intention, there is provided a method in a base station having an internal clock, the method comprising: providing time information to, and receiving time information from, a system node having communication links with a plurality of base stations inclusive of the instant base station; and in an indirect external time epoch reference disciplined mode: receiving time synchronization information from the system node; and controlling the internal clock of the base station based on the time synchronization information to synchronize the internal clock of the base station with a system time reference generated by the system node, wherein the system time reference is synchronized with an external time epoch reference provided by a global navigation satellite system GNSS.

In some embodiments, the method further comprises: in a direct external time epoch reference disciplined mode; receiving a GNSS signal from the GNSS system, the GNSS signal containing the external time epoch reference; and controlling the internal clock of the base station based on the external time epoch reference to synchronize the internal clock with the external time epoch reference.

In some embodiments, the method further comprises: switching from the indirect external time epoch reference disciplined mode to the direct external time epoch reference disciplined mode upon determining that a lock on the GNSS signal has been established; and switching from the direct external time epoch reference disciplined mode to the indirect external time epoch reference disciplined mode upon determining that a lock on the GNSS signal has been lost.

In some embodiments, the method further comprises; sending an external time epoch reference lock status message to the system node indicative of whether the base station is locked to the GNSS signal.

In some embodiments, exchanging time information with the system node comprises exchanging time information according to a two-way time transfer protocol.

In some embodiments, communication between the base station and the system node is packet-based.

According to still another broad aspect of the present invention, there is provided a base station comprising: a communication interface configured for communication with a system node; a local oscillator; and an internal clock controller configured to: control the local oscillator; generate an internal clock based on an output of the local oscillator; provide time information to, and receive time information from the system node via the communication interface; and in an indirect external time epoch reference disciplined mode: receive time synchronization information from the system node via the communication interface; and control the local oscillator based on the time synchronization information to synchronize the internal clock of the base station with a system time reference generated by the system node, wherein the system time reference is synchronized with an external time epoch reference provided by a global navigation satellite system GNSS.

In some embodiments, the base station further comprises: a global navigation satellite system GNSS receiver configured to receive a GNSS signal from the GNSS system, the GNSS signal containing the external time epoch reference, wherein in a direct external time epoch reference disciplined mode, the internal clock controller is configured to receive a GNSS signal from the GNSS system and control the local oscillator based on the external time epoch reference contained in the GNSS signal to synchronize the internal clock with the external time epoch reference.

In some embodiments, the GNSS receiver comprises an assisted-Global Positioning System A-GPS receiver.

In some embodiments, the internal clock controller is configured to: switch from the indirect external time epoch reference disciplined mode to the direct external time epoch reference disciplined mode upon determining that a lock on the GNSS signal has been established; and switch from the direct external time epoch reference disciplined mode to the indirect external time epoch reference disciplined mode upon determining that a lock on the GNSS signal has been lost.

In some embodiments, the internal clock controller is configured to send an external time epoch reference lock status message via the communication interface to the system node indicative of whether the GNSS receiver is locked to the GNSS signal.

In some embodiments, the communication interface is configured to provide time information to, and receive time information from, the system node according to a two-way time transfer protocol.

In some embodiments, the communication interface is configured for packet-based communication.

According to another aspect of the present invention, there is provided:

a technique to enable base transceiver stations to communicate synchronization and syntonization information over a backhaul connection;

a technique to use synchronization alarm signals from base transceiver stations to transfer the alarmed base transceiver station clock reference to a network clock signal delivered from an alternate functional base transceiver station so as to maintain system synchronization;

a technique to compare the time alignment of an array of base station clocks at a common node in the backhaul network of the base transceiver stations;

a technique of using the comparison of N base station clocks in phase at a common network node for the purpose of identifying clock signals that are not time aligned to a system time defined by an external time epoch reference such as GPS; and

a technique to transfer synchronization information over the backhaul between N base transceiver stations for the purpose of maintaining synchronization information of the base transceiver stations in the event that one to N−1 base transceiver stations lose synchronization to a primary synchronization reference applied at each base station, such as an external time epoch reference provided by a GNSS service.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying drawings, in which;

FIG. 1 is a schematic diagram of a communication system in accordance with an embodiment of the invention;

FIG. 2 is a block diagram of another communication system in accordance with an embodiment of the invention;

FIG. 3 is a block diagram of a system node and two base stations configured and arranged in accordance with an embodiment of the invention; and

FIG. 4 is a flowchart of an example of a method in a system node in communication with a plurality of base stations, each having an internal clock, according to an embodiment of the invention.

### DETAILED DESCRIPTION

In the following detailed description of sample embodiments, reference is made to the accompanying drawings, which form a part hereof, and in which is shown by way of illustration specific sample embodiments in which the present invention may be practised. These embodiments are described in sufficient detail to enable those skilled in the art to practice the invention, and it is to be understood that other embodiments may be utilized and that logical, mechanical, electrical, and other changes may be made without departing from the scope of the invention. The following detailed description is, therefore, not to be taken in a limiting sense, and the scope is defined by the appended claims.

Various methods and apparatus are provided for multiple redundant global navigation satellite system (GNSS) synchronization of base stations in a communication system.

The techniques of the present invention enable the comparison of GNSS disciplined base station clocks at a system node that is common to all base stations, such as a backhaul switch node common to all base stations. Some embodiments utilize a comparison of the base station clock phases, i.e. relative time offsets, in addition to lock information messages from GNSS receivers to determine if a base station clock is in time error. If a time error is detected, i.e. the base station clock has lost synchronization with an external time epoch reference provided by the GNSS service, the common switch node provides time synchronization information to the base station that is in time error. The time synchronization information is based on a system time reference generated at the common switch node based on time information communicated with those base stations that are still synchronized with the external time epoch reference.

Embodiments of the present invention leverage the existing redundancy of multiple existing GNSS disciplined internal clocks located respectively at a plurality of base stations to potentially increase operational robustness of the base stations against loss of GNSS service. In this manner, at least some embodiments of the present invention may overcome the current single point of failure mechanism present in many conventional base station GNSS-based architectures by utilizing the availability of surrounding base station clocks that are still synchronized with an external time epoch reference provided by the GNSS service, to generate time synchronization information for one or more base stations that have lost the GNSS service and/or are located such that the GNSS service is unavailable, for example, in a tunnel. Accordingly, some embodiments of the present invention may facilitate the extension of system time synchronization to base stations deployed in locations that are unable to directly receive GNSS synchronization signals.

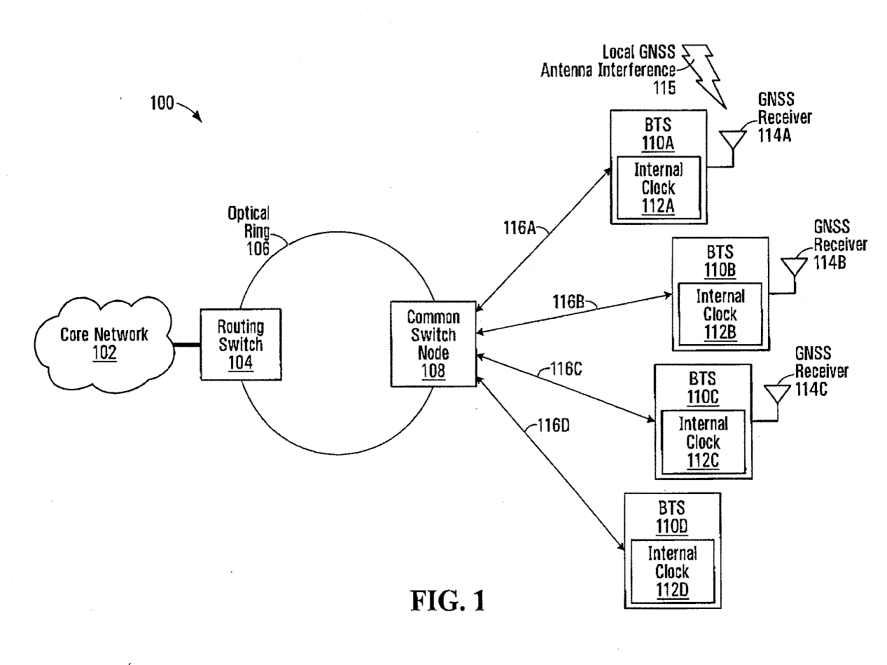

An example of a communication system arranged and configured in accordance with an embodiment of the present invention will now be described with reference to FIG. 1.

FIG. 1 is a block diagram of a communication system 100 arranged and configured in accordance with an embodiment of the present invention. Communication system 100 includes a common switch node 108 and a plurality of base stations, BTS 110A to BTS 110D. Common switch node 108 is one example of a system node in which embodiments of the present invention might be realized. Common switch node 108 has a respective communication link, 116A to 116D respectively, with each of BTS 110A to BTS 110D.

In the embodiment illustrated in FIG. 1, common switch node 108 is connected to a core network 102 via an optical ring 106 and a routing switch 104. More generally, common switch node 108 may be connected to core network 102 through any backhaul network topology.

Each of BTS 110A to BTS 110D has a respective internal clock, 112A to 112D respectively. BTS 110A, BTS 110B and BTS 110C each have a respective GNSS receiver, 114A, 114B and 114C respectively. BTS 110D does not have a GNSS receiver.

In operation, common switch node 108 exchanges time information with each of BTS 110A to BTS 110D via respective communication links 116A to 116D, and generates a system time reference based on at least some of the time information exchanged with at least one of BTSs 110A to BTS 110D that has its internal clock synchronized with an external time epoch reference provided by a GNSS system.

For a base station of the plurality of base stations that does not have its internal clock synchronized with an external time epoch reference contained within a GNSS synchronization signal received via a GNSS receiver, such as GNSS receivers 114A to 114C, common switch node 108 provides time synchronization information to the base station to synchronize the internal clock of the base station with the system time reference. For example, at the instant depicted in FIG. 1, BTS 110A has lost GNSS service due to local GNSS antenna interference, generally indicated at 115 in FIG. 1. As such, internal clock 112A is likely to lose synchronization with the external time epoch reference provided by the GNSS service. Upon determining that BTS 110A has lost synchronization with the external time epoch reference, which may be indicated, for example, by an external time epoch reference lock status message generated by BTS 110A or by a determination at common switch node 108 that the time information received from BTS 110A has deviated from the system time reference generated based on at least some of the time information exchanged with at least one of the base stations that has retained synchronization with the external time epoch reference, common switch node 108 provides BTS 110A with time synchronization information to synchronize internal clock 112A with the system time reference. Generating the system time reference based on at least some of the time information from at least one BTSs that is still synchronized with the external time epoch reference means that the system time reference will be synchronized with the external time epoch reference.

Furthermore, it is noted that BTS 110D does not have an GNSS receiver, and thus is incapable of directly receiving a GNSS synchronization signal to discipline internal clock 112D. Accordingly, because BTS 110D is unable to synchronize to the external time epoch reference by receiving a GNSS synchronization signal, common switch node 108 provides time synchronization information to BTS 110D via communication link 116D to synchronize internal clock 112D with the system time reference generated by common switch node 108, which, as noted above, is generated based on time information exchanged with at least one base station, such as BTS 110B and/or BTS 110C, that are still locked to the GNSS synchronization signal and synchronized with the external time epoch reference contained therein, so that the system time reference is synchronized with the external time epoch reference.

In some embodiments, BTS 110D, which is not provided with a GNSS receiver, may be deployed in a location in which it is not possible to directly receive a GNSS synchronization signal, such as a roadway tunnel.

In some embodiments, common switch node 108 and BTS 110A to 110D are configured to exchange time information via communication links 111A to 116D by exchanging time stamp information, wherein common switch node 108 generates time stamp information based on the system time reference and each base station BTS 110A to 110D generates time stamp information based on its internal clock 112A to 112D. In some embodiments, common switch node 108 and BTSs 110A to 110D are configured to exchange time information using a two-way time transfer protocol.

In some embodiments, common switch node 108 includes a switch node clock (not shown in FIG. 1) and common switch node 108 is configured to generate the system time reference by synchronizing the switch node clock with the external time epoch reference based on at least some of the time information exchanged with at least one of BTSs 110A to 110D. In some cases, for each base station with its internal clock synchronized to the external time epoch reference, common switch node 108 is configured to determine a respective time offset between the internal clock of the base station and the switch node clock at the common switch node. Common switch node 108 then controls the switch node clock based on an average of the respective time offsets for those base stations with their internal clock synchronized to the external time epoch reference and generates the system time reference based on an output of the switch node clock.

In some embodiments, for each of BTS 110A to 110D, common switch node 108 generates a respective switch node clock (not shown in FIG. 1) and controls the respective switch node clock based on at least some of the time information exchanged with the respective base station to synchronize the respective switch node clock with the internal clock of the respective base station. In some cases, common switch node 108 generates the system time reference based on an average of the respective switch node clocks corresponding to those base stations with their internal clock synchronized to the external time epoch reference. For example, assuming that BTS 110B and BTS 110C are currently receiving GNSS service via their respective GNSS receivers 114B and 114C, then common switch node 108 may generate the system time reference based on an average of the respective switch node clocks corresponding to BTS 110B and 110C.

In some embodiments, common switch node 108 and BTSs 110A to 110D are configured to communicate via communication links 116A to 116D respectively using packet-based communication.

In the example embodiment illustrated in FIG. 1, BTSs 110A to 110D are assumed to be macrocell base transceiver stations. However, more generally, embodiments of the present invention may be implemented in any base station deployment application including, but not limited to WiMAX, 4G, CDMA, femtocell, Long Term Evolution (LTE) base stations and combinations thereof.

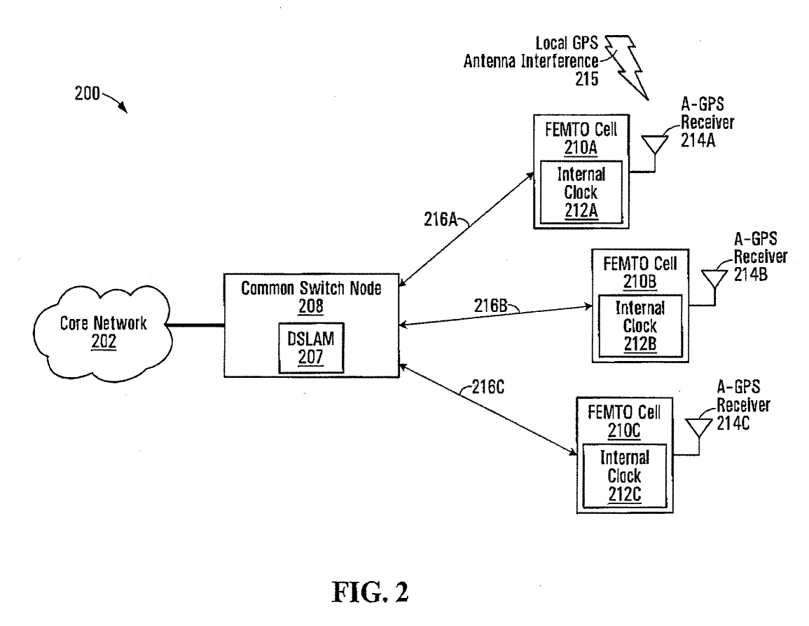

An example of a communication system that includes femto cell base stations in accordance with an embodiment of the present invention will now be described with reference to FIG. 2.

FIG. 2 is a block diagram of a communication system 200 arranged and configured in accordance with another embodiment of the present invention. Communication system 200 includes a common switch node 208 and a plurality of femto cell base stations, FEMTO cells 210A to 210C. Common switch node 208 has a respective communication link, 216A to 216C respectively, with each of FEMTO cells 210A to 210C. In the embodiment illustrated in FIG. 2, communication links 216A to 216C are assumed to be digital subscriber line DSL communication links. In some embodiments, these may be asynchronous digital subscriber line ADSL communication links.

Each of FEMTO cells 210A to 210C has a respective internal clock, internal clocks 212A to 212C respectively, and a respective GNSS receiver, which in the illustrated embodiment are implemented as assisted GPS A-GPS receivers 214A to 214C respectively. In an assisted GPS system a GPS receiver not only receives GPS signals from one or more GPS satellites, but also receives assistance information from one or more network servers to assist in acquiring GPS satellite signals and/or processing acquired GPS satellite signals to lessen the processing that is done at the receiver and to potentially improve start up performance of the GPS receiver. A more complete description of assisted GPS is omitted here for the sake of conciseness.

In the embodiment illustrated in FIG. 2, common switch node 208 is connected to a core network 202 via a backhaul network communication link. Common switch node 208 includes a DSL access multiplexer DSLAM 207. DSLAM 207 multiplexes information destined for core network 202 that is received via DSL communication links 216A to 216C and transmits it via the backhaul network communication link to the core network 202. In some embodiments, the backhaul network communication link may be an optical link.

In operation, common switch node 208 operates in the same way as common switch node 108 described above with reference to FIG. 1 in order to maintain GPS synchronization of FEMTO cells 210A to 210C. That is, common switch node 208 exchanges time information with FEMTO cells 210A to 210C and generates a system time reference synchronized with the external time epoch reference provided by the GPS service based on at least some of the time information exchanged with at least one of FEMTO cells 210A to 210C that is still synchronized with the external time epoch reference provided by the GPS service. If a femto cell loses synchronization with the external time epoch reference, common switch node 208 provides time synchronization information to the femto cell to synchronize the internal clock of the femto cell with the system time reference, which is synchronized to the external time epoch reference, thereby indirectly re-synchronizing the femto cell with the external time epoch reference.

In the instant depicted in FIG. 2, FEMTO cell 210 is unable to receive GPS service due to local GPS antenna interference generally indicated at 215. Upon determining that FEMTO cell 210A has lost synchronization with the external time epoch reference provided by the GPS service, common switch node 208 provides FEMTO cell 210A with time synchronization information to synchronize internal clock 212A with the system time reference generated at common switch node 20B. As noted above, generating the system time reference based on at least some of the time information exchanged with at least one of the femto cells that is still synchronized with the external time epoch reference means that the system time reference will be synchronized with the external time epoch reference.

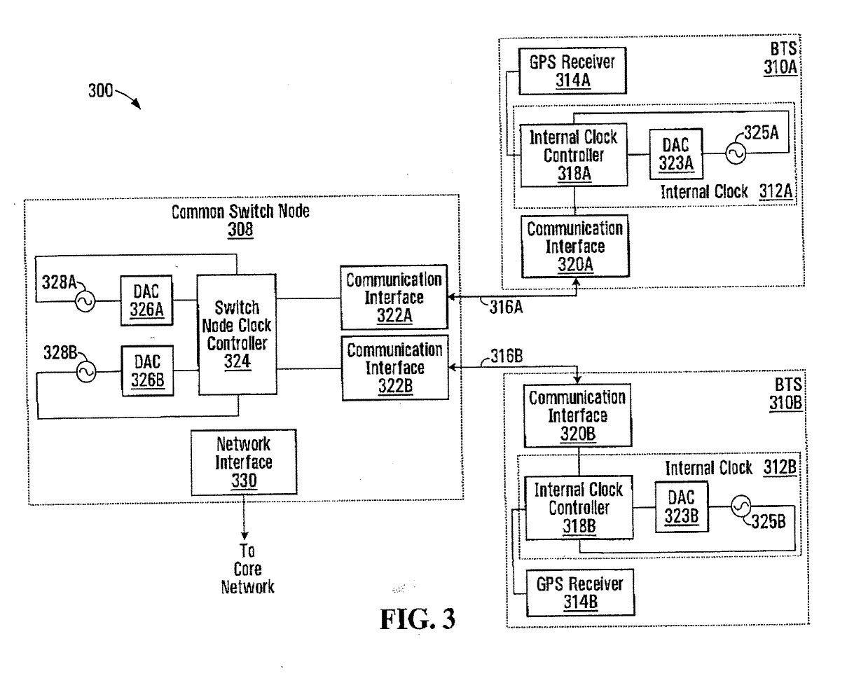

A discussion of components that may be included as part of a common switch node and a base station in accordance with an example embodiment of the present invention will now be provided with reference to FIG. 3.

FIG. 3 is a block diagram of a communication system 300 that includes a common switch node 308 and two base stations BTS 310A and 310B configured and arranged in accordance with an example embodiment of the present invention.

Common switch node 308 includes two communication interfaces 322A and 322B, a switch node clock controller 324, two digital to analog converters DACs 326A and 326B, two oscillators 328A and 328B and a backhaul network interface 330. Communication interfaces 322A and 322B are functionally connected to switch node clock controller 324. Switch node clock controller 324 has respective functional connections to DACs 326A and 326B, which are in turn functionally connected to oscillators 328A and 328B respectively. Oscillators 328A and 328B each have a respective output functionally connected to switch node clock controller 324. Network interface 330 provides a communication interface to a core network (not shown in FIG. 3).

Each of BTSs 310 includes a respective GPS receiver 314A and 314B respectively, a respective internal clock 312A and 312B respectively and a respective communication interface 320A and 320B respectively. Internal clock 312A includes an internal clock controller 318A, a DAC 323A and an oscillator 325A, while internal clock 312B includes an internal clock controller 318B, a DAC 323B and an oscillator 325B.

Internal clock controller 318A is functionally connected to DAC 323A, which is in turn functionally connected to oscillator 325A. An output of oscillator 325A is functionally connected to an input of internal clock controller 318A. GPS receiver 314A is also functionally connected to GPS receiver 314A and communication interface 320A. The elements of BTS 310B are arranged in the same manner as the corresponding elements of BTS 310A. Communication interfaces 320A and 320B of BTS 310A and BTS 310B respectively are functionally connected to communication interface 322A and communication interface 322B of common switch node 308 respectively via communication links 316A and 316B respectively.

In operation, when BTS 310A and 310B are both receiving GPS synchronization signals and are synchronized with an external time epoch reference provided by the GPS service, the internal clock controllers 318A and 318B discipline the oscillators 325A and 325B based on the external time epoch reference contained in GPS synchronization signal received via GPS receivers 314A and 314B respectively. This maintains internal clocks 312A and 312B in time-alignment with the external time epoch reference. In the illustrated embodiment, internal clock controllers 318A and 318B generate digital control signals, which DACs 323A and 323B convert into analog control signals to apply to analog control inputs of the oscillators 325A and 325B respectively.

Communication interfaces 320A and 3200B exchange time information with communication interfaces 322A and 322B of common switch node 308 via communication links 316A and 316B respectively.

In the illustrated embodiments, common switch node 308 includes a respective oscillator, oscillators 328A and 328B respectively, for BTSs 310A and 310B. Switch node clock controller 324 generates a respective switch node clock based on an output of each oscillator 328A and 328B. For each base station, switch node clock controller 324 controls the respective oscillator based on the time information exchanged with the base station to synchronize the respective switch node clock, which the switch node clock controller generates based on the output of the respective oscillator, with the internal clock of the base station. Switch node clock controller 324 also generates a system time reference based on an average of the respective switch node clocks corresponding to those base stations that remain synchronized to the external time epoch reference provided by the GPS service. For example, while both BTS 310A and BTS 320B are receiving GPS synchronization signals such that their internal clocks 312A and 312B respectively are synchronized with the external time epoch reference provided by the GPS service, switch node clock controller 324 synchronizes oscillators 328A and 328B with oscillators 325A and 325B respectively, and generates a system time reference as an average of the switch node clocks generated based on the outputs of oscillators 328A and 328B.

If, for example, BTS 310A loses GPS service, while GPS service is maintained at BTS 310B, then switch node clock controller 324 generates the system time reference based on the switch node clock generated based on the output of oscillator 328B and sends time synchronization information to BTS 310A via communication link 316A for use by internal clock controller 318A to control oscillator 325A so that internal clock 312A is synchronized with the system time reference generated at common switch node 308. Because the system time reference generated at common switch node 308 is based on an output of oscillator 328B, which is synchronized to oscillator 325B through the exchange of time information between switch node 308 and BTS 310B, synchronization of oscillator 325A in BTS 310A with the system time reference will also synchronize oscillator 325A with the external time epoch reference, as long as BTS 310B continues to receive GPS service and oscillator 310B is synchronized with the external time epoch reference.

In some embodiments, the communication interfaces 320A, 320B, 322A and 322B are configured to exchange time information by exchanging time stamp information. For example, in some embodiments the communication interfaces 322A and 322B are configured to generate time stamp information based on the switch node clocks generated from outputs of the oscillators 328A and 328B respectively and receive time stamp information from the communication interfaces 320A and 320B of BTSs 310A and 310B respectively, which are generated based on the internal clocks 312A and 312B respectively.

In FIG. 3, common switch node 308 includes a respective oscillator for each base station. In another embodiment, common switch node 308 includes only one oscillator, regardless of the number of base stations. In such an embodiment, switch node clock controller 324 is configured to generate a switch node clock from an output of that oscillator. Furthermore, switch node clock controller 324 is configured to generate the system time reference based on an output of the switch node clock.

In some embodiments, the communication interfaces 322A and 322B are configured to exchange time information with the plurality of base stations by exchanging time stamp information, wherein the communication interfaces 322A and 322B are configured to generate time stamp information based on the system time reference generated by switch node clock controller 324 and receive time stamp information from each base station generated based on the base station's internal clock.

In some embodiments, the switch node clock controller 324 is configured to generate the system time reference by synchronizing the switch node clock with the external time epoch reference based on at least some of the time information exchanged with at least one base station that is still synchronized with the external time epoch reference provided by the GPS service.

In some embodiments, for each base station with its internal clock synchronized to the external time epoch reference, switch node clock controller 324 is configured to determine a respective time offset between the internal clock of the base station and the switch node clock at the common switch node and control the switch node clock based on an average of the respective time offsets for those base stations with their internal clock synchronized to the external time epoch reference.

In some embodiments, the communication interfaces 322A, 322B, 320A and 320B are two-way time transfer protocol interfaces.

In some embodiments, the internal clock controller 318A and 318B of BTSs 310A and 310B are configured to send an external time epoch reference lock status message via their respective communication interface 320A and 320B to common switch node 308 indicative of whether their respective GPS receiver 314A and 314B is locked to a GPS signal.

In some embodiments, switch node clock controller 324 is configured to provide the time synchronization information to a base station pursuant to receiving an external time epoch reference lock status message from the base station that indicates that the internal clock of the base station has lost synchronization with the external time epoch reference.

In some embodiments, switch node clock controller 324 is configured to determine that the internal clock of a base station of the plurality of base stations has lost synchronization with the external time epoch reference based on a deviation of the time information received from the base station relative to the system time reference.

BTSs 310A and 310B are configured to operate in two modes: an indirect external time epoch reference disciplined mode and direct external time epoch reference disciplined mode.

In the indirect external time epoch reference disciplined mode, the internal clock controllers 318A and 318B are configured to receive time synchronization information from common switch node 308 and control their respective local oscillators based on the time synchronization information to synchronize their respective internal clocks with the system time reference generated by the common switch node.

In the indirect external time epoch reference disciplined mode, the internal clock controllers 318A and 318B are configured to control their local oscillator based on the external time epoch reference contained in a GPS signal received by their respective GPS receivers to synchronize their respective internal clocks with the external time epoch reference.

In some embodiments, internal clock controllers 318A and 318B are configured to switch from the indirect external time epoch reference disciplined mode to the direct external time epoch reference disciplined mode upon determining that a lock on the GPS signal has been established.

In some embodiments, internal clock controllers 318A and 318B are configured to switch from the direct external time epoch reference disciplined mode to the indirect external time epoch reference disciplined mode upon determining that a lock on the GNSS signal has been lost.

In some embodiments, the time information exchanged between common switch node 308 and BTSs 310A and 310B may be time stamp information generated based on the oscillators 325A and 325B of BTSs 310A and 310B respectively and time stamp information generated based on outputs of oscillators 328A and 328B of common switch node 308.

In some embodiments, communication interfaces 322A, 322B, 320A and 320B are implemented as MAC/PHY interfaces operated in accordance with a two-way time transfer protocol, such as that defined in IEEE Standard 1588 for synchronizing clocks. The IEEE Standard 1588 is hereby incorporated by reference in its entirety.

In some embodiments, the oscillators 328A and 328B are implemented as numerical oscillators, which may be implemented, for example, in a logic device such as an FPGA or any other hardware/firmware implementation, or combination of hardware/firmware and software implementation, suitable for implementing the logical operations of a numerical oscillator. In some embodiments, the functionality of switch node clock controller 324 may be implemented in the same or different hardware/firmware or combination of hardware/firmware and software implementation.

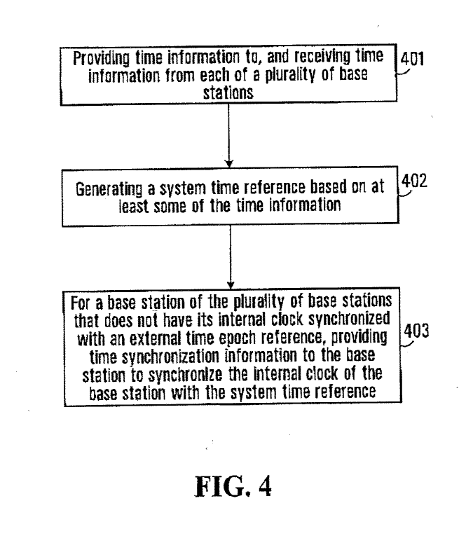

An example of a method in a system node, such a backhaul switch node, for multiple redundant GNSS synchronization of a plurality of base stations in communication with the system node will now be described with reference to the flowchart of FIG. 4.

At block 401, the system node provides time information to, and receives time information from, each of the plurality of base stations. This may, for example, involve exchanging time stamps with each of the base stations. In some embodiments, the switch node and the base stations may exchange time stamp information using a two-way time transfer protocol.

At block 402, the backhaul switch node generates a system time reference that is synchronized to an external time epoch reference based on at least some of the time information exchanged with at least one base station of the plurality of base stations that has its internal clock synchronized with an external time epoch reference provided by a GNSS service.

At block 403, for a base station of the plurality of base stations that does not have its internal clock synchronized with the external time epoch reference, the backhaul switch node provides time synchronization information to the base station to synchronize the internal clock of the base station with the system time reference, which is synchronized with the external time epoch reference. In this way, the backhaul switch node uses the GNSS synchronized internal clock of at least one base station that is synchronized with the external time epoch signal, to generate time synchronization information for a base station that has lost synchronization with the external time epoch reference.

In the embodiments described above, the device elements and circuits are connected to each other as shown in the Figures, for the sake of simplicity. In practical applications of the present invention, elements, circuits, etc. may be connected directly to each other. As well, elements, circuits etc. may be connected indirectly to each other through other elements, circuits, etc., necessary for operation of the devices or apparatus. Thus, in actual configuration of devices and apparatus, the elements and circuits are directly or indirectly coupled with or connected to each other.

Although the embodiments discussed herein have assumed a direct connection between each base station and the system node, some embodiments may compensate for the asymmetric delay that can potentially be introduced by an intervening node that is located between a base station and the system node. An asymmetric delay in exchange of time information between the system node and a base station, i.e. a difference in the time taken to send time information from the base station to the system node relative to the time taken to send time information from the system node to the base station, can potentially lead to a degradation in the time accuracy of the synchronization that is achievable. Depending on the required time accuracy, some degree of asymmetry may be tolerated without any need to compensate for it. In some embodiments, the asymmetry introduced by an intervening node may be modelled at the system node to account for the asymmetry when generating the system time reference and providing the time synchronization information.

The foregoing description includes many detailed and specific embodiments that are provided by way of example only, and should not be construed as limiting the scope of the present invention. Alterations, modifications and variations may be effected to the particular embodiments by those of skill in the art without departing from the scope of the invention, which is defined solely by the claims appended hereto.

1. A method in a system node, the system node in communication with a plurality of base stations each having an internal clock, the method comprising:
providing time information to, and receiving time information from, each of the plurality of base stations;
generating a system time reference based on at least some of the time information; and
for a base station of the plurality of base stations that does not have its internal clock synchronized with an external time epoch reference, providing time synchronization information to the base station to synchronize the internal clock of the base station with the system time reference.

2. The method of claim 1, wherein generating a system time reference based on at least some of the time information comprises:
generating a system time reference based on at least some of the time information received from at least one base station that has its internal clock synchronized with the external time epoch reference.

3. The method of claim 2, wherein providing time information to, and receiving time information from, each of the plurality of base stations comprises:
for each base station:
providing time stamp information to, and receiving time stamp information from, the base station, wherein the system node generates time stamp information based on the system time reference and the base station generates time stamp information based on its internal clock.

4. The method of claim 3, wherein generating the system time reference comprises synchronizing a system node clock at the system node with the external time epoch reference based on the at least some of the time information.

5. The method of claim 4, wherein generating the system time reference comprises:
for each base station with its internal clock synchronized to the external time epoch reference, determining a respective time offset between the internal clock of the base station and the system node clock at the system node; and
controlling the system node clock based on an average of the respective time offsets for those base stations with internal clocks synchronized to the external time epoch reference; and
generating the system time reference based on an output of the system node clock.

6. The method of claim 3, wherein generating the system time reference comprises:
for each base station, generating a respective system node clock at the system node and controlling the respective system node clock based on at least some of the time information received from the base station to synchronize the respective system node clock with the internal clock of the base station; and
generating the system time reference based on an average of the respective system node clocks corresponding to those base stations with their internal clock synchronized to the external time epoch reference.

7. (canceled)

8. (canceled)

9. (canceled)

10. (canceled)

11. A system node comprising:
a communication interface configured to provide time information to, and receive time information from, a plurality of base stations, each having an internal clock;
a system node clock; and
a system node clock controller configured to:
control the system node clock based on at least some of the time information received from at least one of the plurality of base stations;
generate a system time reference based on an output of the system node clock; and
for a base station of the plurality of base stations that does not have its internal clock synchronized with an external time epoch reference, provide time synchronization information to the base station to synchronize the internal clock of the base station with the system time reference.

12. The system node of claim 11, wherein the system node clock controller is configured to control the system node clock based on at least some of the time information received from each base station that has its internal clock synchronized with the external time epoch reference.

13. The system node of claim 12, wherein the communication interface is configured to provide time information to, and receive time information from the plurality of base stations by providing and receiving time stamp information, wherein the communication interface is configured to generate time stamp information based on the system time reference and receive time stamp information from each base station generated based on the base station's internal clock.

14. The system node of claim 13, wherein the system node clock controller is configured to generate the system time reference by synchronizing the system node clock with the external time epoch reference based on at least some of the time information received from at least one base station of the plurality of base stations that has its internal clock synchronized with the external epoch time reference.

15. The system node of claim 14, wherein the system node clock controller is configured to:
for each base station with its internal clock synchronized to the external time epoch reference, determine a respective time offset between the internal clock of the base station and the system node clock at the system node; and
control the system node clock based on an average of the respective time offsets for those base stations with their internal clock synchronized to the external time epoch reference.

16. The system node of claim 13, wherein the system node clock comprises a respective system node clock for each base station, and wherein the system node clock controller is configured to:
for each base station, control the respective system node clock based on at least some of the time information received from the base station to synchronize the respective system node clock with the internal clock of the base station; and
generate the system time reference based on an average of the respective system node clocks corresponding to those base stations with their internal clock synchronized to the external time epoch reference.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A method in a base station having an internal clock, the method comprising:
providing time information to, and receiving time information from, a system node having communication links with a plurality of base stations inclusive of the instant base station; and
in an indirect external time epoch reference disciplined mode:
receiving time synchronization information from the system node; and
controlling the internal clock of the base station based on the time synchronization information to synchronize the internal clock of the base station with a system time reference generated by the system node, wherein the system time reference is synchronized with an external time epoch reference provided by a global navigation satellite system GNSS.

34. The method of claim 33, further comprising:
in a direct external time epoch reference disciplined mode:
receiving a GNSS signal from the GNSS system, the GNSS signal containing the external time epoch reference; and
controlling the internal clock of the base station based on the external time epoch reference to synchronize the internal clock with the external time epoch reference.

35. The method of claim 34, further comprising:
switching from the indirect external time epoch reference disciplined mode to the direct external time epoch reference disciplined mode upon determining that a lock on the GNSS signal has been established; and
switching from the direct external time epoch reference disciplined mode to the indirect external time epoch reference disciplined mode upon determining that a lock on the GNSS signal has been lost.

36. The method of claim 35, further comprising:
sending an external time epoch reference lock status message to the system node indicative of whether the base station is locked to the GNSS signal.

37. The method of claim 33, wherein exchanging time information with the system node comprises exchanging time information according to a two-way time transfer protocol.

38. (canceled)

39. A base station comprising:
a communication interface configured for communication with a system node;
a local oscillator; and
an internal clock controller configured to:
control the local oscillator;
generate an internal clock based on an output of the local oscillator;
provide time information to, and receive time information from, the system node via the communication interface; and
in an indirect external time epoch reference disciplined mode:
receive time synchronization information from the system node via the communication interface; and
control the local oscillator based on the time synchronization information to synchronize the internal clock of the base station with a system time reference generated by the system node, wherein the system time reference is synchronized with an external time epoch reference provided by a global navigation satellite system GNSS.

40. The base station of claim 39, further comprising:
a global navigation satellite system GNSS receiver configured to receive a GNSS signal from the GNSS system, the GNSS signal containing the external time epoch reference,
wherein in a direct external time epoch reference disciplined mode, the internal clock controller is configured to receive a GNSS signal from the GNSS system and control the local oscillator based on the external time epoch reference contained in the GNSS signal to synchronize the internal clock with the external time epoch reference.

41. The base station of claim 40, wherein the GNSS receiver comprises an assisted-Global Positioning System A-GPS receiver.

42. The base station of claim 40, wherein the internal clock controller is configured to:
switch from the indirect external time epoch reference disciplined mode to the direct external time epoch reference disciplined mode upon determining that a lock on the GNSS signal has been established; and
switch from the direct external time epoch reference disciplined mode to the indirect external time epoch reference disciplined mode upon determining that a lock on the GNSS signal has been lost.

43. The base station of claim 42, wherein the internal clock controller is configured to send an external time epoch reference lock status message via the communication interface to the system node indicative of whether the GNSS receiver is locked to the GNSS signal.

44. The base station of claim 39, wherein the communication interface is configured to provide time information to, and receive time information from, the system node according to a two-way time transfer protocol.

45. (canceled)
